(19) United States
(12) Patent Application Publication
(10) Pub. No.: US 2026/0238731 A1
(43) Pub. Date: Aug. 13, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Atsuya Baba, Kanagawa (JP)

(73) Assignee: FUJIFILM Business Innovation Corp., Tokyo (JP)

(21) Appl. No.: 19/312,659

(22) Filed: Aug. 28, 2025

(30) Foreign Application Priority Data
Feb. 10, 2025 (JP) 2025-020285

(51) Int. Cl. H04N 1/00; H04N 1/23

(52) U.S. Cl. CPC H04N 1/0071; H04N 1/00702; H04N 1/00721; H04N 1/00771; H04N 1/00777; H04N 1/2323; H04N 1/2338; H04N 1/2392; H04N 2201/0091

(57) ABSTRACT

An information processing system includes a processor configured to: before starting reading of an image from a document, acquire width information of the document; acquire first setting information related to a size and an orientation of a sheet corresponding to the acquired width information; acquire second setting information related to a stamp formation position corresponding to the acquired size and orientation of the sheet; and present the acquired first setting information and the acquired second setting information in association with each other.

### CROSS-REFERENCE TO RELATED APPLICATIONS

This application is based on and claims priority under 35 USC 119 from Japanese Patent Application No. 2025-020285 filed Feb. 10, 2025.

### BACKGROUND

### (i) Technical Field

The present disclosure relates to an information processing system and a non-transitory computer readable medium.

### (ii) Related Art

Some printing apparatuses have a function of setting, for each document size, a size of a sheet on which an image read from a document is to be printed. When this function is enabled, an orientation and a size of the image to be printed may be changed in accordance with the size of the sheet to be used for output. Some printing apparatuses have a function of designating a stamp printing position for each size of the sheet.

Examples of the related art include Japanese Unexamined Patent Application Publication No. 2023-155507.

### SUMMARY

A user does not always know a relationship between a size of a document and a size or an orientation of a sheet. Similarly, a user does not always know a stamp printing position set for each size of a sheet. In this case, a positional relationship between an image printed on the sheet output from a printing apparatus and a stamp may differ from what is assumed by the user.

Aspects of non-limiting embodiments of the present disclosure relate to preventing a duplicate from being discarded due to a relationship between a duplicated image and a stamp position being different from what is assumed, unlike a case where a relationship between a setting related to duplication of a document and a setting related to addition of a stamp cannot be confirmed before printing of a duplicate with a stamp.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: before starting reading of an image from a document, acquire width information of the document; acquire first setting information related to a size and an orientation of a sheet corresponding to the acquired width information; acquire second setting information related to a stamp formation position corresponding to the acquired size and orientation of the sheet; and present the acquired first setting information and the acquired second setting information in association with each other.

### BRIEF DESCRIPTION OF THE DRAWINGS

Exemplary embodiments of the present disclosure will be described in detail based on the following figures, wherein:

FIG. 1 is a diagram for describing a configuration example of a printing system assumed in an exemplary embodiment;

FIG. 2 is a diagram for describing an example of an auto-mode setting screen;

FIG. 3 is a diagram illustrating an example of a basic copy screen;

FIG. 4 is a diagram for describing an example of an auto-mode setting screen;

FIG. 5 is a diagram for describing an example of a stamp position setting screen;

FIG. 6 is a flowchart for describing an example of processing operations executed by the printing system;

FIG. 7 is a diagram for describing an example of a screen that presents a relationship among a sheet size, a sheet orientation, a stamp position, and a stamp printing orientation to be used in copy printing of a document;

FIG. 8 is a diagram for describing a specific example of auto-mode setting and stamp position setting; and

FIG. 9 is a diagram for describing an output example of copy printing based on initial settings and an output example after the stamp position is changed.

### DETAILED DESCRIPTION

Hereinafter, exemplary embodiments of the present disclosure will be described with reference to the drawings.

### First Exemplary Embodiment

### <System Configuration>

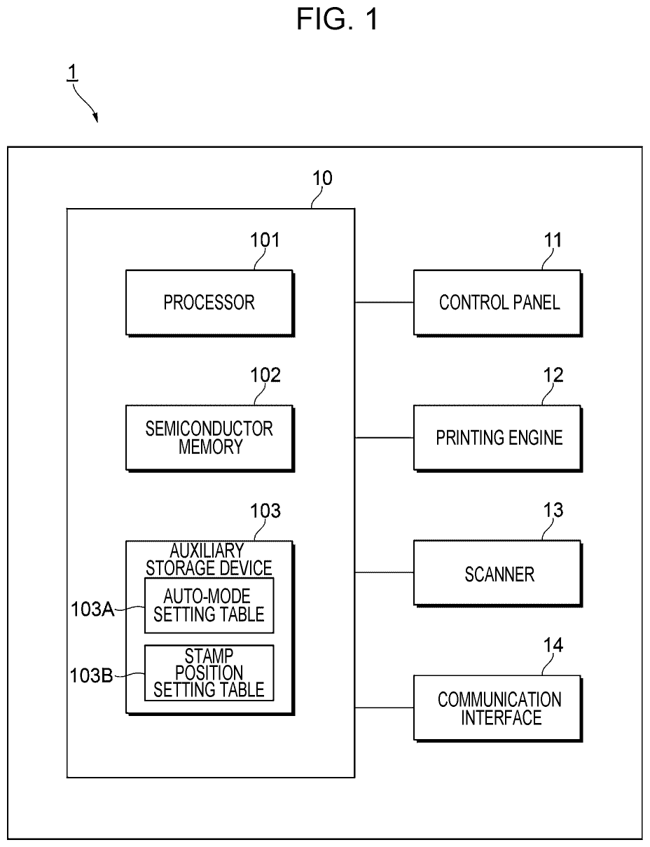

FIG. 1 is a diagram for describing a configuration example of a printing system 1 assumed in an exemplary embodiment. The printing system 1 is one form of an information processing system.

The printing system 1 according to the present exemplary embodiment is assumed to be a standalone image forming apparatus. That is, an apparatus in which the units illustrated in FIG. 1 are housed in a single casing is assumed.

According to the present exemplary embodiment, the printing system 1 is assumed to be an image forming apparatus that supports sheets wider than A3 size or A4 size, such as A2 size or A0 size. That is, the printing system 1 according to the present exemplary embodiment also supports printing on a long sheet with a larger aspect ratio than that of the A3 size. This printing system 1 of this type may be referred to as a “wide-width output device” or a “wide-width multifunction peripheral”.

The printing system 1 illustrated in FIG. 1 includes a control board 10, a control panel 11, a printing engine 12, a scanner 13, and a communication interface 14.

The control board 10 includes, for example, a processor 101, a semiconductor memory 102, and an auxiliary storage device 103.

The processor 101 is a semiconductor integrated circuit that implements various functions by executing programs. Examples of the programs include firmware, a unified extensible firmware interface (UEFI), and an application program. The firmware is a program for controlling the operation of the entire system. The firmware is, for example, a program for controlling the operations and functions of the control panel 11, the printing engine 12, and the scanner 13. The UEFI is a program for controlling a startup process of a computer. The processor 101 according to the present exemplary embodiment executes, for example, a copy printing job or another printing job by executing a program.

The semiconductor memory 102 includes, for example, a read only memory (ROM) and a random access memory (RAM) that is used as a work area of the processor 101.

The auxiliary storage device 103 is configured with, for example, a hard disk device or a semiconductor storage. The auxiliary storage device 103 stores, for example, programs, image data read from a document, printing jobs, and various settings. In the present exemplary embodiment, an auto-mode setting table 103A and a stamp position setting table 103B are stored as the various settings.

In the present exemplary embodiment, an auto-mode is assumed to be a copy printing mode in which an image read from a document is printed on a sheet.

In the auto-mode according to the present exemplary embodiment, reading of a document and printing of an image on a sheet are executed simultaneously in parallel. In other words, even when the reading of the document has not been completed, printing of the image on the sheet is started.

In the auto-mode setting table 103A, combinations of sheet sizes and image rotation directions corresponding to combinations of orientations and sizes of documents to be inserted into the scanner 13 are stored. Hereinafter, a case where a document size is the same as a sheet size is referred to as equal-magnification copy. On the other hand, a case where a sheet size is smaller than a document size is referred to as reduced copy, and a case where a sheet size is larger than a document size is referred to as enlarged copy.

When an auto-mode setting is enabled, the processor 101 determines a sheet size, an orientation of an image, and the like based on the settings in the auto-mode setting table 103A, and prints a read image on a sheet.

When the auto-mode is executed, an operation of setting a size of a sheet to be used for printing and an image rotation direction is not required prior to copy printing. As a result, the number of user operations is reduced, and productivity is improved.

The term “stamp” refers to a predetermined symbol, character string, or the like to be printed on a sheet. Examples of the symbol, character string, and the like used as the stamp include “confidential”, “circulation”, “reference”, “urgent”, “careful handling”, “important”, “copy”, “draft”, and “date”.

The stamp position setting table 103B stores settings for designating a position of the stamp on a sheet on which the stamp is to be printed. In the present exemplary embodiment, the stamp position is set for each size or orientation of the sheet. When printing of a stamp is designated, the stamp is printed at a set position.

The auto-mode setting and the stamp position setting are independent of each other.

When the auto-mode setting is enabled but the stamp printing setting is disabled, printing of an image is started based on a sheet size and a rotation direction associated with a combination of an insertion orientation and a size of a document.

When both the auto-mode setting and the stamp printing setting are enabled, image printing is automatically started based on the sheet size and the rotation direction associated with the combination of the insertion orientation and the size of the document. Furthermore, a stamp is printed at a position set in association with the size and the orientation of the sheet on which the image is to be printed.

The control panel 11 is a device that accepts user operations. The control panel 11 is provided with, for example, a touch panel, buttons, and switches. The touch panel is, for example, a device having a structure in which capacitive translucent thin-film sensors are stacked on a surface of a display. The touch panel is an example of a device having functions of both an input device and an output device. The buttons and the switches are examples of mechanical operators. Hereinafter, various screens displayed on the touch panel are also referred to as operation screens.

The printing engine 12 is a device that prints information on a sheet or another medium. The printing engine 12 according to the present exemplary embodiment also executes various kinds of processing related to the printing of information. For example, the printing engine 12 also executes functions related to rasterizing processing, density correction, sharpness correction, contrast correction, and background color removal. A mechanism of the printing engine 12 varies depending on a printing scheme. For example, the mechanism of the printing engine 12 is different between a photo printing scheme and an inkjet scheme.

A mechanism for transporting a medium (that is, a transport mechanism) varies depending on whether a sheet or another medium is cut paper or roll paper.

The scanner 13 is a device that optically reads information on a surface of a document. The scanner 13 supports at least one of a scheme of moving a reading unit relative to a stationary document and a scheme of moving a document relative to a stationary reading unit. The present exemplary embodiment employs the latter scheme, that is, the scheme of moving the document relative to the image reading unit.

The communication interface 14 is a module that implements communication with external terminals. The communication interface 14 includes, for example, a module used for connecting to a wired or wirelessly connected local area network (LAN). The communication interface 14 includes, for example, a Universal Serial Bus (USB) module.

### <Auto-Mode and Stamp Position Setting>

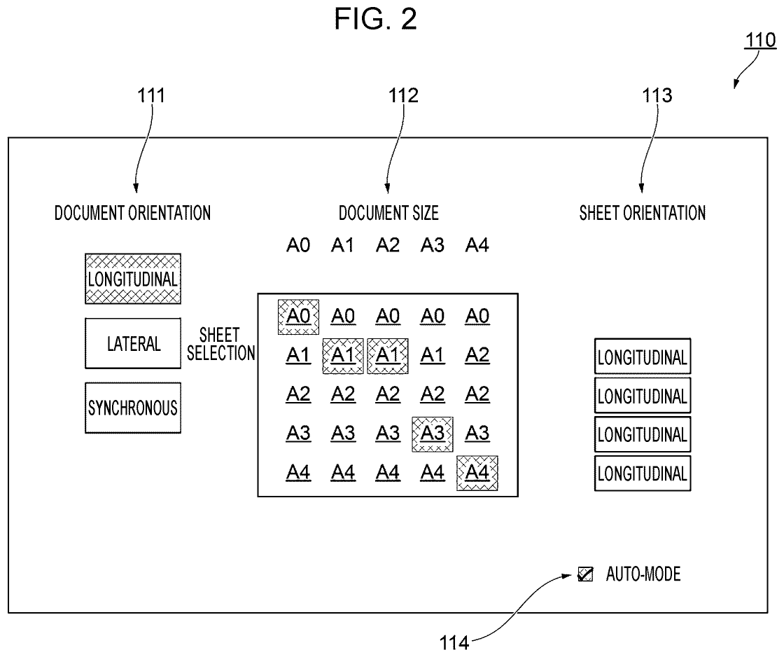

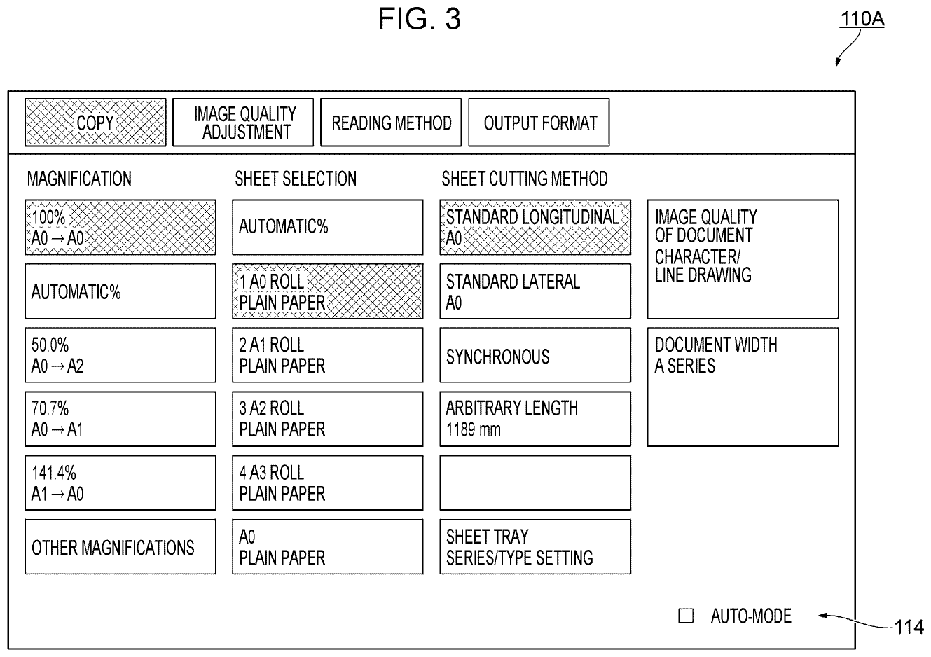

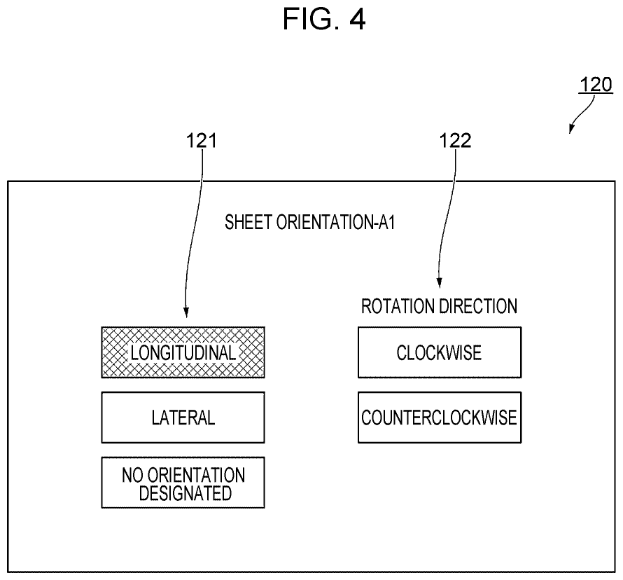

FIG. 2 is a diagram for describing an example of an auto-mode setting screen 110. FIG. 3 is a diagram illustrating an example of a basic copy screen 110A. FIG. 4 is a diagram for describing an example of an auto-mode setting screen 120. The setting screen 110, the basic copy screen 110A, and the setting screen 120 are displayed on the control panel 11 (see FIG. 1). In FIG. 3, parts corresponding to those in FIG. 2 are denoted by the same reference numerals.

The setting screen 110 is used to set a document orientation and a relationship between a document size and a size of a sheet to be used for printing.

The setting screen 110 includes a document orientation setting field 111, a setting field 112 for a document size and a size of a sheet to be used for printing, a sheet orientation setting field 113, and an auto-mode check box 114.

The auto-mode check box 114 is used to select execution or non-execution of copy printing in the auto-mode.

In the case of FIG. 2, a check mark is displayed in the auto-mode check box 114. The auto-mode check box 114 is also shaded. These displays mean that the auto-mode is selected. In other words, this means that the auto-mode setting is enabled.

In the printing system 1 (see FIG. 1), there are two types of methods for starting reading of a document: auto-start and manual start, which can be set through the control panel 11 (see FIG. 1).

When the auto-start is set, reading of an image from a document is started by simply inserting a document into an insertion port, and printing of the read image is also automatically started.

In a case of an operation mode in which copy printing is executed after individual designations of a sheet size, a sheet orientation for an image, and the like are accepted (that is, when the operation mode is not the auto-mode), the auto-mode check box 114 is displayed as a white blank field. In this case, the basic copy screen 110A (see FIG. 3) is displayed.

Buttons for selecting a sheet size and magnification are displayed on the basic copy screen 110A. In the case of FIG. 3, equal-magnification printing on the A0 size is set. When the auto-mode check box 114 is selected, the auto-mode setting screen 110 (see FIG. 2) is displayed.

In the case of FIG. 2, three types of options, “longitudinal”, “lateral”, and “synchronous” can be selected in the document orientation setting field 111.

The “longitudinal” orientation refers to a state in which documents are set longitudinally when viewed from the insertion port of the scanner 13 (see FIG. 1). In other words, the “longitudinal” orientation refers to an orientation in which a length in the direction in which the document is carried in (that is, the document length) is longer than a width of the document inserted into the insertion port of the scanner 13. The “longitudinal” orientation here includes “standard longitudinal” when the document size is a standard length.

The insertion port of the scanner 13 is also referred to as a carry-in port of a document. In the present exemplary embodiment, when a “start” button or the like is pressed while a document is inserted into the insertion port of the scanner 13, the document starts to be transported, and the scanner 13 starts reading of an image.

The “lateral” orientation refers to a state in which documents are set laterally when viewed from the insertion port of the scanner 13. In other words, the “lateral” orientation refers to an orientation in which a width of the document to be inserted into the insertion port of the scanner 13 is longer than the length in the direction in which the document is carried in (that is, document length). The “lateral” orientation here includes “standard lateral” when the document size is a standard length.

The “synchronous” orientation refers to a non-standard document. In other words, this means that the document size is none of the “A0” size, the “A1” size, and . . . the “A4” size. In the present exemplary embodiment, the “synchronous” orientation refers to a long document having an aspect ratio larger than that of the “A0” size. When the “synchronous” orientation is set, the sheet is cut so that the length of the document is the same as the length of the sheet. For example, roll paper is used for this type of printing.

In the case of FIG. 2, the selected state is represented by shading. Therefore, a “longitudinal” orientation is selected in the document orientation setting field 111.

In the setting field 112 for the document size and the size of the sheet to be used for printing, combinations of document sizes and sheet sizes are displayed in a matrix format. In the case of FIG. 2, a horizontal axis (or horizontal direction) represents a document size, and a vertical axis (or vertical direction) represents a sheet size. In the case of FIG. 2, there are five types of document sizes and sheet sizes: the “A0” size, the “A1” size, the “A2” size, the “A3” size, and the “A4” size. However, selectable sizes are not limited to these.

In the case of FIG. 2, “A0” of the document size is set to be associated with “A0” of the sheet size. “A1” of the document size is set to be associated with “A1” of the sheet size. In other words, equal-magnification copy is set for these two types of document size.

Further, “A2” of the document size is associated with “A1” of the sheet size. With regard to this document size, enlarged copy is set.

Regarding the document sizes “A3” and “A4”, equal-magnification copy is set for both.

With the sheet orientation setting field 113, the orientation of the sheet to be output from the printing system 1 can be selected. In the case of the present exemplary embodiment, three types of options, “longitudinal”, “lateral”, and “no orientation designated” can be selected. The “longitudinal” orientation refers to a state in which copies (duplicates) are discharged in a longitudinal orientation when viewed from a discharge port. The “lateral” orientation refers to a state in which copies (duplicates) are discharged in a lateral orientation when viewed from the discharge port. When “no orientation designated” is set, a sheet having the same orientation as that of the document is preferentially output.

In the case of FIG. 2, sheet orientations are described in association with sheet sizes. With the exception of the “A0” size, a “longitudinal” orientation is set. Since the “A0” size does not correspond to the selection of the sheet orientation, the corresponding orientation is not described and is left blank.

The setting screen 120 is used to set the sheet orientation. When any of the items in the sheet orientation setting field 113 is selected, the screen transitions from the setting screen 110 to the setting screen 120.

In the case of FIG. 4, the sheet orientation setting screen 120 corresponding to the “A1” size of the sheet is displayed. For this reason, “sheet orientation-A1” is displayed in the title of the setting screen 120.

The setting screen 120 includes an orientation designation field 121 and a rotation direction designation field 122.

In the orientation designation field 121, three types of options “longitudinal”, “lateral”, and “no orientation designated” are displayed. In the case of FIG. 2, “longitudinal” is shaded. Shading indicates a selected state.

In the rotation direction designation field 122, two types of options “clockwise” and “counterclockwise” are displayed. In the case of FIG. 2, neither “clockwise” nor “counterclockwise” is shaded. This state means that the image read by the scanner 13 (see FIG. 1) is printed in the same orientation as that in which the image has been read (that is, in a non-rotated state).

When it is desired to rotate the image, either “clockwise” or “counterclockwise” may be selected.

When the auto-mode check box 114 (see FIG. 2) is checked, the information set on the setting screen 110 (see FIG. 2) and the setting screen 120 are recorded in the auto-mode setting table 103A.

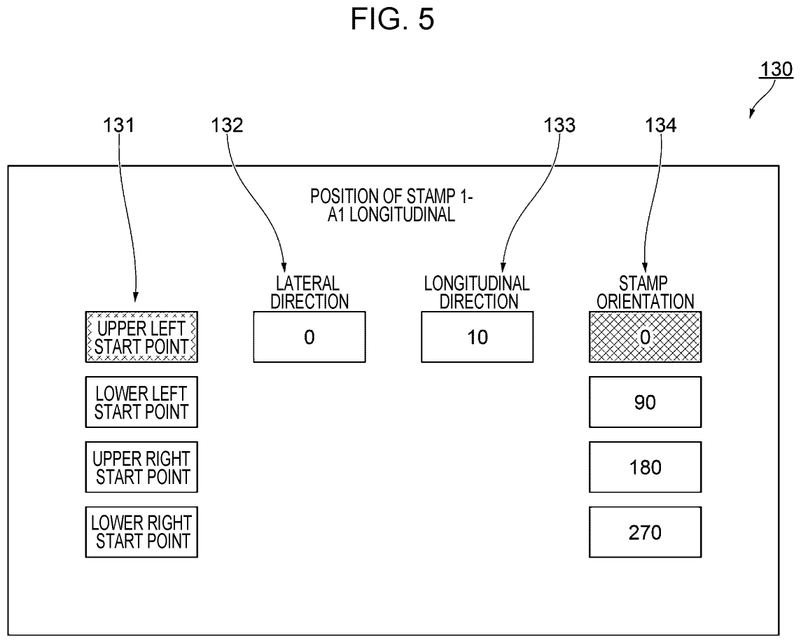

FIG. 5 is a diagram for describing an example of a stamp position setting screen 130. This setting screen is also displayed on the control panel 11 (see FIG. 1). The setting screen 130 is an example of a second screen for accepting a setting of the second setting information.

The stamp position setting screen 130 is transitioned from an unillustrated setting screen on which execution or non-execution of stamp printing can be selected. Therefore, display is possible both when executing copy printing in the auto-mode and when not executing copy printing in the auto-mode.

That is, setting of whether to perform stamp printing and the printing position can be set independently of the selection of the auto-mode.

The stamp position setting screen 130 includes a start-point designation field 131, a lateral position designation field 132, a longitudinal position designation field 133, and a stamp orientation designation field 134.

The title of the setting screen 130 illustrated in FIG. 5 indicates that a type of a stamp is a “stamp 1”, a size of a sheet to be used for printing is an “A1” size, and a sheet orientation is a “longitudinal” orientation.

As described above, the stamp position can be set for each combination of the type of stamp to be printed, the sheet size, and the sheet orientation.

The start-point designation field 131 is used to designate a start point of the stamp position. In the case of FIG. 5, four types of options, an “upper left start point”, a “lower left start point”, an “upper right start point”, and a “lower right start point” can be selected in the start-point designation field 131. In other words, which of the four corners of the sheet is to be used as a start point is designated in the start-point designation field 131.

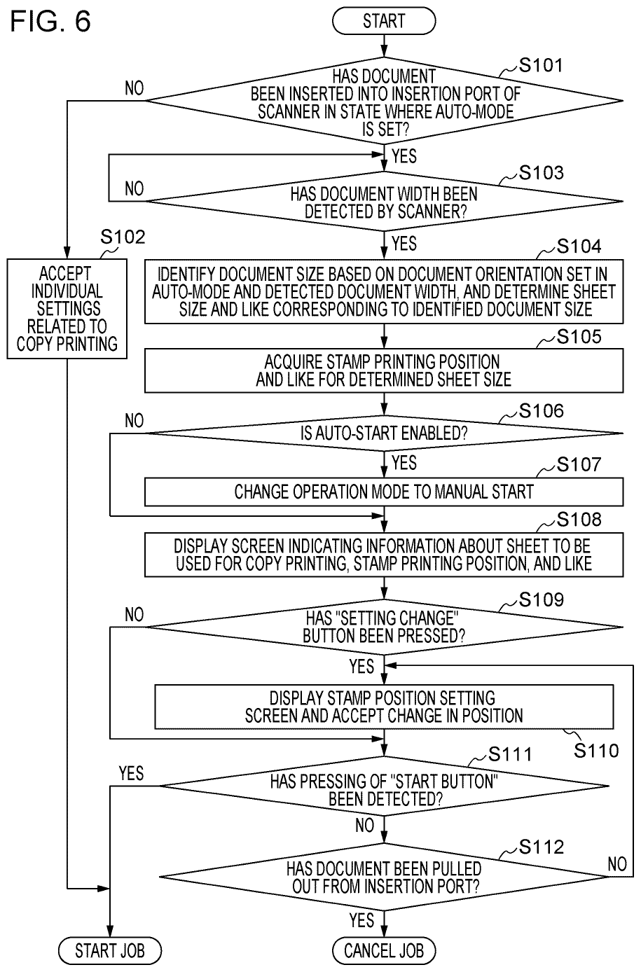

With the lateral position designation field 132, a distance in the lateral direction from the start point to the area where the stamp is to be printed is designated. The lateral direction corresponds to a longitudinal direction of the discharge port of the printing engine 12 (see FIG. 1). In the case of FIGS. 6, 0 mm is set.

With the longitudinal position designation field 133, a distance in the longitudinal direction from the start point to the area where the stamp is to be printed is designated. The vertical direction corresponds to a direction in which a sheet is discharged from the printing engine 12. In the case of FIGS. 6, 10 mm is set.

The stamp orientation designation field 134 is used to designate the printing orientation of the stamp with respect to the start point. In the case of FIG. 5, four types of options, 0°, 90°, 180°, and 270° can be selected. In the case of FIG. 5, the 0° field is shaded. That is, 0° is selected. When 90° is selected, the stamp is printed in a state of being rotated counterclockwise by 90°. When 180° is selected, the stamp is printed in an upside-down state (that is, a state where a top and a bottom are inverted). When 270° is selected, the stamp is printed in a state of being rotated counterclockwise by 270°.

Information set through the setting screen 130 is recorded in the stamp position setting table 103B (see FIG. 1).

The information that can be set through the setting screen 110 illustrated in FIG. 2 and the setting screen 120 illustrated in FIG. 4 is an example of first setting information. The size and orientation of the sheet described above are an example of the first setting information.

The information that can be set on the setting screen 130 illustrated in FIG. 5 is an example of the second setting information. The stamp formation position corresponding to the size and orientation of the sheet described above is an example of the second setting information.

The auto-mode described above is an example of a job for starting copy printing on the condition that the first setting information and the second setting information are acquired. The copy printing includes a job for starting reading of an image from a document and a job for printing the read image on a sheet.

### <Processing Operations of Printing System 1>

FIG. 6 is a flowchart for describing an example of processing operations executed by the printing system 1. The symbol S illustrated in FIG. 6 represents a step.

The processing operations illustrated in FIG. 6 are implemented by the processor 101 (see FIG. 1) executing a program.

First, the processor 101 determines whether a document has been inserted into the insertion port of the scanner 13 (see FIG. 1) in a state where the auto-mode is set (step 101). When the insertion of a document into the insertion port of the scanner 13 has not been confirmed, the determination in step 101 is repeated.

When the insertion of a document into the insertion port of the scanner 13 has been confirmed but the auto-mode has not been set, a negative result is obtained in step 101. In this case, the processor 101 accepts individual settings related to copy printing (step 102). With the individual settings, it is possible to set a size of a sheet on which an image read from a document is to be printed, a sheet orientation, an image rotation direction, and the like. It is also possible to set whether to perform stamp printing, a printing position, and the like.

When the individual settings are completed, the processor 101 starts a job. The job is copy printing of a document. That is, reading of an image from a document and printing of the read image onto a sheet are executed simultaneously in parallel.

On the other hand, when the insertion of the document into the insertion port of the scanner 13 has been confirmed in a state where the auto-mode is set, a positive result is obtained in step 101. When a positive result is obtained in step 101, a copy printing job in the auto-mode is generated.

In this case, the processor 101 determines whether the scanner 13 has detected a document width (step 103). The document width refers to a width of the document inserted into the insertion port of the scanner 13. The detection of the document width is executed, for example, until a leading end of the document comes into contact with the back of the insertion port. When the document width is the same as a standard size, a document size is also identified. The document width is also an example of width information.

When the document width has not been detected, a negative result is obtained in step 103. In this case, the processor 101 repeats the determination in step 103.

On the other hand, when the document width has been detected, a positive result is obtained in step 103. In this case, the processor 101 identifies the document size based on a document orientation set in the auto-mode and the detected document width, and determines a sheet size and the like corresponding to the identified document size (step 104). For example, with reference to the auto-mode setting table 103A (see FIG. 1), the processor 101 determines the sheet size, the sheet orientation, the image rotation direction, and the like corresponding to the document size and the insertion orientation.

Next, the processor 101 acquires a stamp printing position and the like for the determined sheet size (step 105). For example, with reference to the stamp position setting table 103B (see FIG. 1), the processor 101 acquires information on a printing position and an orientation of the stamp relative to a start point set for each sheet size.

In the present exemplary embodiment, after step 105, the processor 101 determines whether auto-start is enabled (step 106). When auto-start is enabled, it means that the method for starting reading of the document is set to auto-start.

When auto-start is enabled, a positive result is obtained in step 106. In this case, the processor 101 changes the operation mode to manual start (step 107).

In other words, the processor 101 cancels the setting of auto-start or suspends the execution of auto-start.

When auto-start is disabled (that is, when the auto-mode check box 114 is not checked), a negative result is obtained in step 106.

After step 107 is executed, or when a negative result is obtained in step 106, the processor 101 displays a screen indicating information about the sheet to be used for copy printing, the stamp printing position, and the like (step 108). In this display, setting information for the stamp printing position is displayed, based on the sheet size identified by the document width.

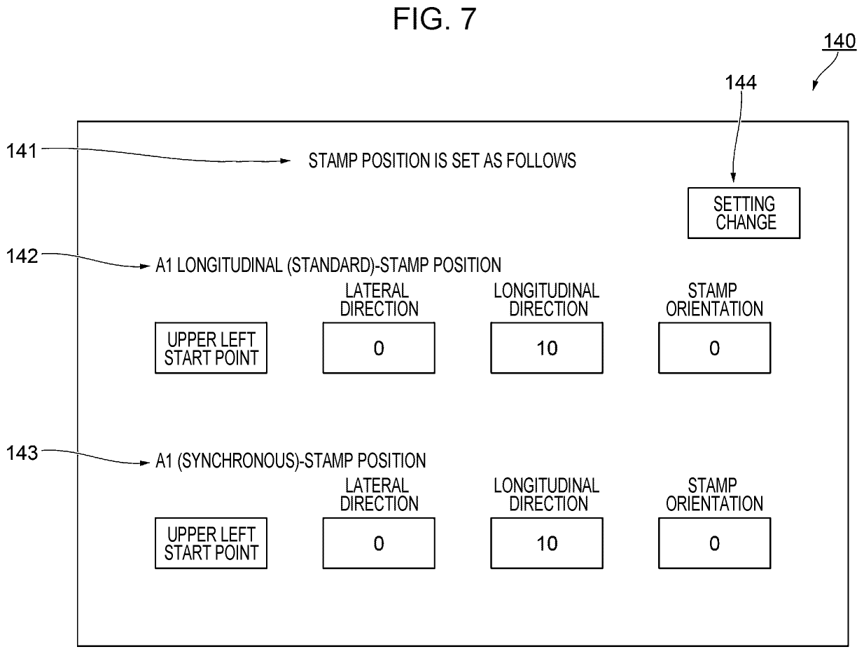

FIG. 7 is a diagram for describing an example of a screen 140 that presents a relationship among a sheet size, a sheet orientation, a stamp position, and a stamp printing orientation to be used in copy printing of a document. The screen 140 is an example of a screen for presenting first setting information and second setting information in association with each other before reading of an image from a document is started.

The screen 140 illustrated in FIG. 7 includes a setting content description field 141, information fields 142 and 143 indicating a relationship among the size of the sheet to be used for copy printing, the stamp printing position, and the stamp printing orientation, and a “setting change” button 144. In other words, the “setting change” button 144 is displayed in association with the information fields 142 and 143 indicating the relationship among the size of the sheet to be used for copy printing, the stamp printing position, and the stamp printing orientation.

In the setting content description field 141, information describing a setting content of this time (or current) is displayed. In the case of FIG. 7, “The stamp position is set as follows” is displayed in the setting content description field 141.

In the case of FIG. 7, the relationship among the size of the sheet to be used in copy .printing, the stamp printing position, and the stamp printing orientation is displayed in the information fields 142 and 143.

The information field 142 indicates information such as a stamp position when the size of the sheet to be used for copy printing is the standard size. In the case of FIG. 7, the sheet size is “A1 longitudinal”. This information represents that the image read from the document is to be printed and output on a sheet of “A1” size in a “longitudinal” orientation.

In the case of FIG. 7, it is indicated that a stamp is to be printed at a position of 0 mm in the “lateral direction” and 10 mm in the “longitudinal direction” with the upper left position of the sheet of “A 1” size as a start point. The stamp printing orientation is 0°. That is, the stamp is to be printed without being rotated.

The information field 143 indicates information such as a stamp position when the document has the non-standard size. In the case of FIG. 7, it can be seen that the sheet width is the “A1” size.

In the case of FIG. 7, it is indicated that a stamp is to be printed at a position of 0 mm in the “lateral direction” and 10 mm in the “longitudinal direction” with the upper left of the sheet as a start point. The stamp printing orientation is 0°. That is, the stamp is to be printed without being rotated.

The “setting change” button 144 is an operator for giving an instruction to display a screen for accepting a change in the stamp position. The “setting change” button 144 is an example of an operator for giving an instruction to display a screen for accepting a change in the second setting information.

The description returns to FIG. 6.

Next, the processor 101 determines whether the “setting change” button 144 has been pressed (step 109).

When the “setting change” button 144 has been pressed, a positive result is obtained in step 109. In this case, the processor 101 displays the stamp position setting screen 130 (see FIG. 5) and accepts a change in position (step 110).

The stamp position setting screen 130 is an example of a second screen for accepting a change in the second setting information.

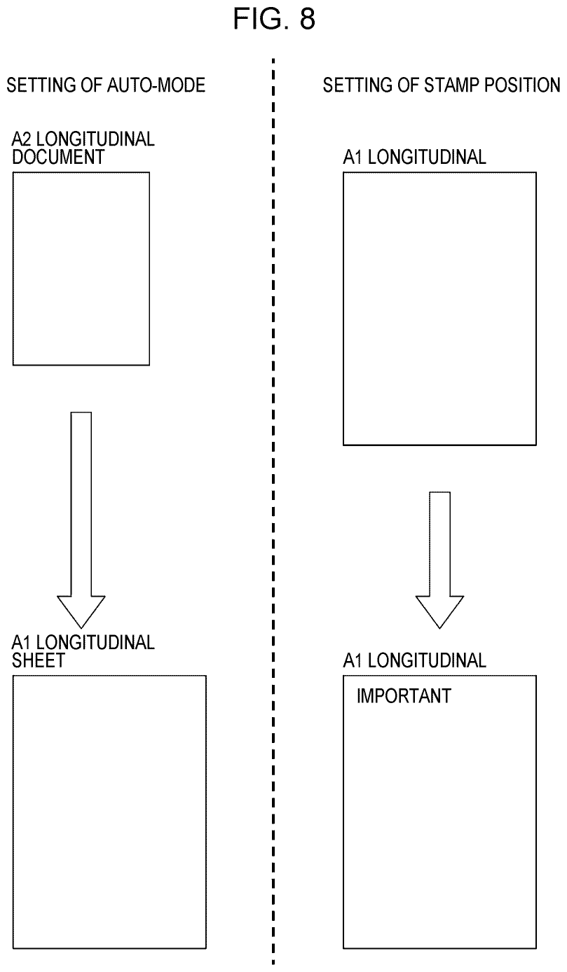

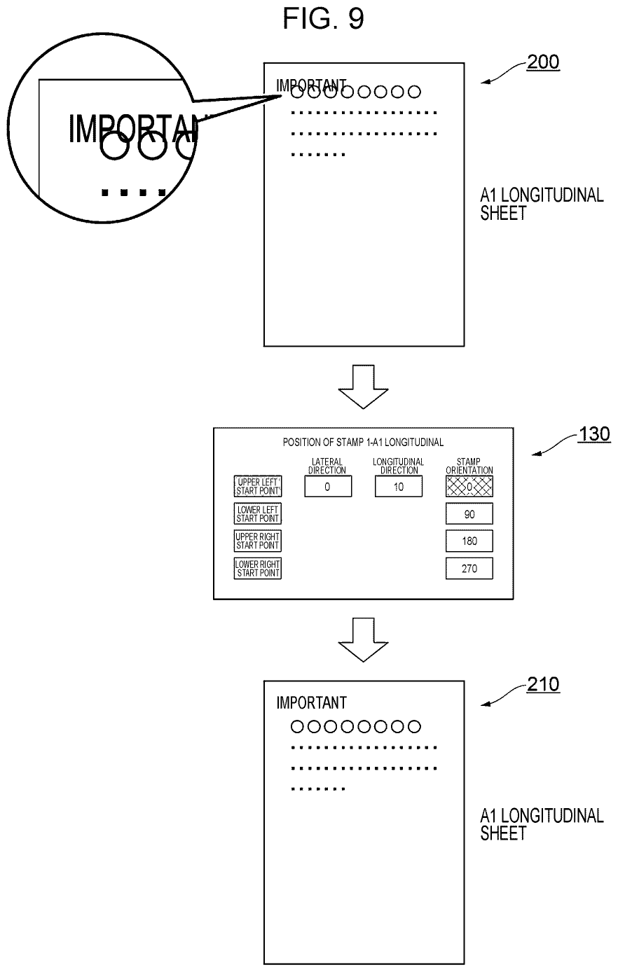

Here, using FIGS. 8 and 9, a specific example of accepting a change in the stamp position will be described.

FIG. 8 is a diagram for describing a specific example of the auto-mode setting and the stamp position setting. In the case of FIG. 8, when a document of “A2” size is inserted in the “longitudinal” orientation, an image read from the document is printed on a sheet of “A1” size. As illustrated in FIG. 8, according to the stamp position setting, a stamp is to be printed near the upper left corner of a sheet of an “A1” size having a “longitudinal” orientation with a rotation of 0°.

FIG. 9 is a diagram for describing an output example 200 of copy printing based on initial settings and an output example 210 after the stamp position is changed.

The user who is scheduled to execute copy printing in the auto-mode knows a layout of the document inserted into the insertion port. For this reason, when the screen 140 (see FIG. 7) is displayed, the user can imagine the position at which the stamp is to be printed and the printing orientation. As a result, as in the output example 200, the user can easily notice beforehand that the stamp may overlap with the image of the document. In addition, the user can also notice that the stamp printing orientation is different from the assumed one (for example, an orientation rotated by 90°).

When the stamp position is changed through the stamp position setting screen 130 as described above, the stamp can be printed at a position and in a direction suitable for the document subject to copy printing, as illustrated in the output example 210.

The changed setting content accepted in step 110 may be applied only for the document of this time (or current) or may be applied to all documents subject to copy printing. Which setting is to be adopted depends on the specifications of the program.

In the present exemplary embodiment, the stamp position setting table 103B (see FIG. 1) is updated. That is, the changed setting content is applied to all subsequent copy printing. Of course, the stamp position setting screen 130 (see FIG. 6) or the screen 140 may be provided with an operator for selecting whether to apply the stamp position to only the copy printing of this time (or current) or to all subsequent copy printing.

The description returns to FIG. 6.

When a negative result is obtained in step 109 (that is, when the “setting change” button 144 has not been pressed) or after step 110 is executed, the processor 101 determines whether pressing of a “start” button (not illustrated) has been detected (step 111).

The “start” button is an operator for giving an instruction to start copy printing. Pressing the “start” button here is an example of a predetermined third operation.

When the pressing of the “start” button has been detected, a positive result is obtained in step 111. In this case, the processor 101 starts a job. That is, copy printing is started. In the copy printing in the present exemplary embodiment, reading an image from a document and printing the read image onto a sheet are executed simultaneously in parallel.

On the other hand, when the pressing of the “start” button has not been detected, a negative result is obtained in step 111. In this case, the processor 101 determines whether the document has been pulled out from the insertion port (step 112). The operation of pulling out the document from the insertion port is an example of an operation of removing a document and is also an example of a predetermined second operation.

When the document has not been pulled out from the insertion port, a negative result is obtained in step 112. In this case, the processor 101 returns the process to step 110.

When the document has been pulled out from the insertion port, a positive result is obtained in step 112. In this case, the processor 101 cancels the job. As a result, execution of wasteful copy printing due to incorrect settings is avoided.

### <Summary>

As described above, with the printing system 1 (see FIG. 1) according to the present exemplary embodiment, there is an opportunity to confirm a relationship between a document to be read and a stamp position or the like before starting copy printing in the auto-mode. For this reason, before a duplicate of the document is generated, it is possible to check in advance whether a stamp is to be printed at an assumed position or the like. As a result, it is possible to prevent a duplicate from being discarded due to a relationship between the duplicated image, the position of the stamp, or the like differing from what is assumed.

### <Other Exemplary Embodiments>

(1) While the exemplary embodiment of the present disclosure has been described, the technical scope of the present disclosure is not limited to the scope described in the above exemplary embodiment. It is apparent from the claims that various modifications and improvements to the above-described exemplary embodiment are included within the technical scope of the present disclosure.

(2) The printing system 1 (see FIG. 1) according to the above-described exemplary embodiment includes the control board 10 (see FIG. 1), the control panel 11 (see FIG. 1), the printing engine 12 (see FIG. 1), and the scanner 13 (see FIG. 1). That is, a case where the printing system 1 is an image forming apparatus equipped with a plurality of functions has been described.

However, the printing system 1 may be configured as a plurality of apparatuses, each with an independent casing. For example, the printing system 1 may include an apparatus dedicated to the control panel 11, an apparatus dedicated to a printing function, and an apparatus dedicated to an image reading function.

Note that a function of presenting a correspondence between the first setting information and the second setting information before starting copy printing may be provided in the apparatus dedicated to the printing function or the apparatus dedicated to the image reading function.

The above-described functions may be provided to another information processing apparatus (for example, the apparatus dedicated to the control panel 11 or a print server) that controls the operations of the apparatus or unit dedicated to the printing function and the apparatus dedicated to the image reading function.

(3) In the case of the auto-mode described in the above-described exemplary embodiment, a case where the operation of reading an image from a document and the operation of printing an image on a sheet are performed simultaneously in parallel has been described.

However, after the reading of the image from the document is completed, the operation of printing the image read from the document on the sheet may be started.

(4) In the above-described exemplary embodiment, it is assumed that a document is transported to an image reading position. However, a reading scheme in which a document is not transported and an image reading unit moves relative to the document may be employed. That is, the scanner 13 may be a flatbed scanner.

(5) In the above-described exemplary embodiment, a copy printing job is started on the condition that step 102 is completed. However, the copy printing job may be started on the condition that the operation on the “start” button is accepted. The operation on the “start” button is an example of a predetermined first operation. The first operation may be an operation of giving an instruction to start reading an image from a document or an operation of giving an instruction to start duplicating the image read from the document onto a sheet. Alternatively, the first operation may be an operation of giving an instruction to read an image from a document and to duplicate the image read from the document onto a sheet.

(6) In the exemplary embodiments, the processes are performed by any computer. The computer may perform the processes by using a processor serving as hardware, a program serving as software, or combination of these.

In this case, the processor is configured to perform the processes in the exemplary embodiments in cooperation with the program and may function as a unit or a means in the exemplary embodiments.

The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be configured with hardware such as a central processing unit (CPU), a micro processing unit (MPU), or a programmable logic device such as a field programmable gate array (FPGA), a dedicated circuit for performing a specific process such as an application specific integrated circuit (ASIC), a graphics processing unit (GPU), or a neural processing unit (NPU).

Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage).

The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

(7) The present disclosure is also applicable to a program and a program product.

### APPENDIX

(((1)))

An information processing system comprising:
a processor configured to:
   before starting reading of an image from a document,
   acquire width information of the document;
   acquire first setting information related to a size and an orientation of a sheet corresponding to the acquired width information;
   acquire second setting information related to a stamp formation position corresponding to the acquired size and orientation of the sheet; and
   present the acquired first setting information and the acquired second setting information in association with each other.
      (((2)))

The information processing system according to (((1))), wherein
the processor is configured to:
   start reading of an image from the document after accepting a predetermined first operation.
      (((3)))

The information processing system according to (((2))), wherein
the first operation is an operation of giving an instruction to start reading an image from the document or an operation of giving an instruction to start duplicating the image onto the sheet.
   (((4)))

The information processing system according to any one of (((1))) to (((3))), wherein
the processor is configured to:
   cancel a job generated due to acquisition of the width information after accepting a predetermined second operation.
      (((5)))

The information processing system according to (((4))), wherein
the second operation is an operation of removing the document.
   (((6)))

The information processing system according to any one of (((1))) to (((5))), wherein
the processor is configured to:
   present an operator for giving an instruction to display a second screen for accepting a change or a setting of the second setting information in association with a screen on which the first setting information and the second setting information are presented.
      (((7)))

The information processing system according to (((6))), wherein
the processor is configured to:
   update the second setting information with a content after the change accepted through the second screen.
      (((8)))

The information processing system according to (((6))), wherein
the processor is configured to:
   use a content of the second setting information after the change accepted through the second screen only for the document to be read.
      (((9)))

The information processing system according to any one of (((1))) to (((8))), wherein
the processor is configured to:
   when a function of starting reading of an image from the document is set on a condition that the first setting information and the second setting information are acquired, cancel the setting or suspend execution of the function based on the setting.
      (((10)))
The information processing system according to (((9))), wherein
the processor is configured to:
   start reading of an image from the document when a predetermined third operation is accepted after the first setting information and the second setting information are presented.
      (((11)))

A program causing a computer to execute a process, the process comprising:
before starting reading of an image from a document,
acquiring width information of the document;
acquiring first setting information related to a size and an orientation of a sheet corresponding to the acquired width information;
acquiring second setting information related to a stamp formation position corresponding to the acquired size and orientation of the sheet; and
presenting the acquired first setting information and the acquired second setting information in association with each other.

What is claimed is:

1. An information processing system comprising:
a processor configured to:
before starting reading of an image from a document,
acquire width information of the document;
acquire first setting information related to a size and an orientation of a sheet corresponding to the acquired width information;
acquire second setting information related to a stamp formation position corresponding to the acquired size and orientation of the sheet; and
present the acquired first setting information and the acquired second setting information in association with each other.

2. The information processing system according to claim 1, wherein
the processor is configured to:
start reading of an image from the document after accepting a predetermined first operation.

3. The information processing system according to claim 2, wherein
the first operation is an operation of giving an instruction to start reading an image from the document or an operation of giving an instruction to start duplicating the image onto the sheet.

4. The information processing system according to claim 1, wherein
the processor is configured to:
cancel a job generated due to acquisition of the width information after accepting a predetermined second operation.

5. The information processing system according to claim 4, wherein the second operation is an operation of removing the document.

6. The information processing system according to claim 1, wherein
the processor is configured to:
present an operator for giving an instruction to display a second screen for accepting a change or a setting of the second setting information in association with a screen on which the first setting information and the second setting information are presented.

7. The information processing system according to claim 6, wherein
the processor is configured to:
update the second setting information with a content after the change accepted through the second screen.

8. The information processing system according to claim 6, wherein
the processor is configured to:
use a content of the second setting information after the change accepted through the second screen only for the document to be read.

9. The information processing system according to claim 1, wherein
the processor is configured to:
when a function of starting reading of an image from the document is set on a condition that the first setting information and the second setting information are acquired, cancel the setting or suspend execution of the function based on the setting.

10. The information processing system according to claim 9, wherein
the processor is configured to:
start reading of an image from the document when a predetermined third operation is accepted after the first setting information and the second setting information are presented.

11. A non-transitory computer readable medium storing a program causing a computer to execute a process comprising:
before starting reading of an image from a document,
acquiring width information of the document;
acquiring first setting information related to a size and an orientation of a sheet corresponding to the acquired width information;
acquiring second setting information related to a stamp formation position corresponding to the acquired size and orientation of the sheet; and
presenting the acquired first setting information and the acquired second setting information in association with each other.
